(19) United States
(12) Patent Application Publication
(10) Pub. No.: US 2009/0089218 A1
(43) Pub. Date: Apr. 2, 2009

(54) Guaranteed Lifetime Withdrawal Benefit and Administration Thereof

(76) Inventor: Wendy Catherine McCullough, New Hope, MN (US)

Correspondence Address: FITCH EVEN TABIN AND FLANNERY;Mark W. Hetzler, 120 SOUTH LASALLE STREET, SUITE 1600, CHICAGO, IL, 60603-3406, US

(21) Appl. No.: 11/864,492

(22) Filed: Sep. 28, 2007

(51) Int. Cl. G06Q 40/00; G06F 17/00; G06F 17/10

(52) U.S. Cl. 705/36 R

(57) ABSTRACT

A method for administering a guaranteed lifetime withdrawal benefit including initiating the waiting period, calculating the account value to determine the benefit base, periodically determining the account value, comparing the account value to the benefit base, initiating the withdrawal period by fixing the benefit base and withdrawal percentage, calculating the distribution factor and calculating the guaranteed withdrawal. The method allows for premiums to be made during the waiting period. There is a distribution factor assigned to each premium based upon the date of the premium and the annuitant's age at the date the distribution factor is calculated. An existing average distribution factor is calculated periodically and compared to the attained age factor to determine a new average distribution factor. The resulting guaranteed withdrawal amount is the product of the benefit base and the new current average distribution factor.

### FIELD OF THE INVENTION

The invention relates generally to computer implemented data processing methods for the administration of benefits related to annuity income benefit plans. More specifically, the invention relates to computer implemented data processing methods for the administration of guaranteed lifetime benefits resulting from annuity contracts.

### BACKGROUND OF THE INVENTION

Changing demographics as well as consumption habits and lifestyles have led to continued creativity in investment and money management. The aging of the U.S. population taken together with an increasing emphasis on early retirement has led to careful and deliberate investment activity by individual consumers. At the same time, traditional investment vehicles, most often, do not allow flexibility and liquidity as an individual ages. Health and family concerns, such as assisting grandchildren with educational needs, can outstrip a families' cash flow and require the use of savings. Changes in lifestyle also often need to be addressed. One concern with annuity products is the manner in which they limit the contract owner's liquidity.

Computer aided systems and methods for managing annuities and annuity products have existed for some time. Advances have been made to allow annuity contract owner's more liquidity. For example, U.S. Pat. No. 6,611,815 discloses a data processing method for administering an annuity product having a guarantee of lifetime payments, including establishing a charge for the guarantee of lifetime payments, determining an initial benefit payment to be paid to a beneficiary, determining a subsequent periodic payment, periodically determining an account value, and periodically paying the subsequent payment and reporting the account value to the beneficiary.

The charge for the guarantee of lifetime payments may be established in various ways, including determining a front end charge and deducting the front end charge from an initial deposit, determining a charge to be deducted from each periodic benefit payment, or determining an asset charge and periodically deducting the asset charge from the account value. The teachings of U.S. Pat. No. 6,611,815 rely on and provide for an account value. The typical immediate annuity with life contingencies provides the payments guaranteed by the contract, but does not maintain an account value.

Further, U.S. Pat. No. 7,089,201 discloses an annuity based retirement program which utilizes a variable annuity product with a guaranteed minimum payment. The method disclosed in U.S. Pat. No. 7,089,201 is administered by a process in which deficits (i.e. differences between the minimum payments and what would otherwise be the actual payments when actual payments fall below the minimums) are repaid from future payments. The variable annuity payouts are made with a simple floor guarantee and a program administered by a method that funds current deficiencies (without interest) from future payments.

However, known methods likely can be improved upon. Investment vehicles which delay the setting of guaranteed payouts could be used to optimize flexibility and liquidity. Further, investment vehicles providing a benefit base which provides the potential for growth, would also allow for increasing liquidity and greater guaranteed payments, even during the withdrawal period. Management of the account through risk-based investment vehicles also gives the contract owner a predictable cost base and return on investment.

None of these capabilities seem apparent in methods earlier disclosed.

### SUMMARY OF THE INVENTION

In accordance with a first aspect of the invention, there is provided a method for administering a guaranteed lifetime withdrawal benefit comprising the steps of initiating the waiting period, calculating the account value to determine the benefit base, periodically determining the account value, comparing the account value to the benefit base, initiating the withdrawal period by fixing the benefit base and withdrawal percentage, calculating the distribution factor, and calculating the guaranteed withdrawal.

In accordance with a further aspect of the invention, there is provided a method for administering a guaranteed lifetime withdrawal benefit comprising the steps of adding the guaranteed lifetime withdrawal benefit to an annuity contract, and initiating the withdrawal period by setting the benefit base calculation date and by fixing the benefit base and withdrawal percentage.

The method of the invention allows the contract owner versatility in the selection of investment accounts, and the ability to defer payments, increase withdrawal percentages, and increase benefit base and, in turn, the guaranteed withdrawals.

Further, in accordance with the method of the invention, the contract owner has a variable benefit base which adjusts up to increase the guaranteed withdrawal amount as account value increases. With the method of the invention, the benefit base and corresponding guaranteed withdrawal amount do not adjust down with decreasing account value from negative market performance.

In operation, the method of the invention also provides for an asset-based charge against the underlying investment account value which may be assessed based upon the risk of the investment chosen. There is no benefit payment made to the contract owner. Rather, the method of the invention provides for an account withdrawal up to the guaranteed withdrawal amount while accommodating a required minimum distribution which may reach more than the guaranteed withdrawal amount in any given year.

The Guaranteed Lifetime Withdrawal Benefit (GLWB) added to a deferred Variable Annuity (VA) contract guarantees a minimum lifetime withdrawal amount for the life of the annuitant, even if the accumulated value in the VA contract is reduced to zero due to negative market performance or the longevity of the annuitant. It also guarantees the return of investment in the rider to the contract owner's beneficiary if the annuitant dies before the investment has been returned through guaranteed withdrawals.

The guaranteed withdrawal amount will vary based on the age the rider is added, the age additional premium payments are made, and the length of time the contract owner waits to set guaranteed values. The following, Table 1, of withdrawal factors is exemplary. If more than one premium payment is made, the withdrawal factor for the rider will be weighted based on premium payments.

TABLE 1

Withdrawal Percentage

| Contract Age of | Wait < | Wait > | Wait > | Wait > |
|---|---|---|---|---|
| Premium | 5 years | 5 years | 10 years | 15+ years |
| 50-56 | | | 5.0% | 6.0% |
| 57-61 | | 4.5% | 5.5% | 6.5% |
| 62-66 | 4.0% | 5.0% | 6.0% | 7.0% |
| 67-71 | 4.5% | 5.5% | 6.5% | 7.5% |
| 72-76 | 5.0% | 6.0% | 7.0% | |
| 77-81 | 5.5% | 6.5% | | |
| 82-85 | 6.0% | | | |

The resulting withdrawal factor may be multiplied by the benefit base to determine the guaranteed withdrawal amount. The benefit base is set equal to the initial account value, increased for additional premiums and decreased for partial withdrawals. The benefit base will step up to the account value, if higher, at any contract anniversary. The benefit base will not decrease due to poor market performance.

This withdrawal benefit is available to variable annuity contract holders for an increased charge. Investments are restricted to certain asset allocation investment options, and the amount of the charge varies based on the amount of equity exposure within the allocation. Investment options with a higher equity exposure will have a higher charge.

### BRIEF DESCRIPTION OF THE FIGURES

FIG. 1 is a schematic depiction of one embodiment of a method of administering a guaranteed lifetime withdrawal benefit in accordance with the invention.

FIG. 2 is a schematic depiction of the waiting period of the method of administering a guaranteed lifetime withdrawal benefit in accordance with one embodiment of the invention.

FIG. 3 is a schematic depiction of the withdrawal period of the method of administering a guaranteed lifetime withdrawal benefit in accordance with one embodiment of the invention.

FIG. 4 is a schematic depiction of the waiting period of the method of administering a guaranteed lifetime withdrawal benefit illustrating detailed step-wise processing in accordance with one embodiment of the invention.

FIG. 5 is a schematic depiction of the withdrawal period of the method of administering a guaranteed lifetime withdrawal benefit illustrating detailed step-wise processing in accordance with one embodiment of the invention.

FIG. 6 is a schematic depiction of the partial withdrawal analysis in accordance with one embodiment of the invention illustrating detailed step-wise processing.

FIG. 7 is a schematic depiction of the excess withdrawal analysis in accordance with one embodiment of the invention illustrating detailed step-wise processing.

### DETAILED DESCRIPTION OF THE PREFERRED EMBODIMENT

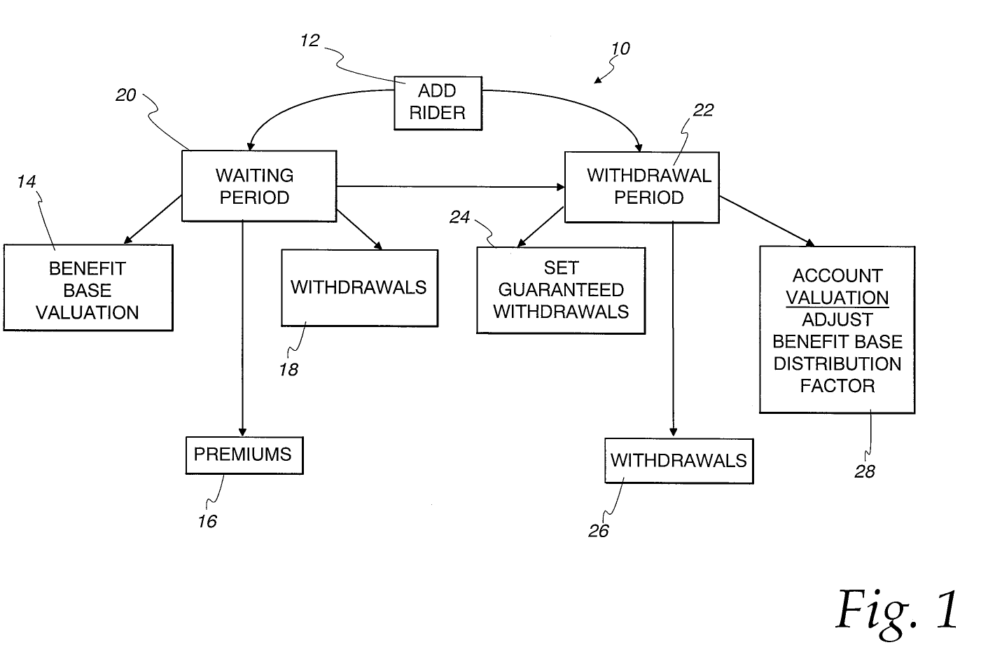

Turning to the figures wherein different embodiments of the invention are shown through differing views with the same or functionally similar elements designated appropriately, a schematic overview of one embodiment of the invention is illustrated in FIG. 1. As can be seen, the method of the invention may comprise a contract or rider which is added to an annuity 12. The operation of the rider may occur through any number of steps.

In one preferred embodiment, the process of the invention operates through a waiting period and a withdrawal period. Generally, the rider waiting period 20, precedes the rider withdrawal period 22. At the same time, the contract owner who adds the rider to an existing annuity product, may immediately elect to enter the rider withdrawal period 22.

The rider waiting period 12 provides a number of functions. First, the waiting period allows the contract owner to set a base valuation for the rider. The base valuation provides an indication of the benefits that the contract owner may ultimately receive from the investment vehicle.

To this end, another function of the waiting period is to allow the rider or contract owner the opportunity to build the benefit base of the rider through premiums. One advantage of the invention is that it allows financial liquidity during certain phases of the process while also guaranteeing lifetime payments. One related advantage of the process of the invention is that the rider owner is given increased or enhanced investment credit for making premiums that are kept in the benefit base for a period of time before withdrawals are taken.

Another function of the waiting period 12 is to allow the rider or contract owner to take withdrawals from the account without triggering the withdrawal period and its associated calculations. Financial liquidity for the contract or rider owner is intended to allow for the non-routine problems which arise during life especially as the rider owner approaches retirement age and cash flow becomes more of an issue.

The withdrawal period 22 may follow the waiting period 12 immediately or after a period of years. The process of the invention allows the rider owner to set their own investment profile which allows for significant flexibility for the contract owner. Here again, the withdrawal period 22 serves a number of functions. One function of the withdrawal period is to set the guaranteed withdrawal amount 24. More specifically, when the contract owner picks the date on which to enter the withdrawal period 22, the benefit base is set and the withdrawal percentage is fixed, 24. This in turn, provides factors which are used to set and adjust the guaranteed withdrawal amount.

A further function of the withdrawal period 22 is to allow for withdrawals 26. Withdrawals may come in any number of forms including guaranteed withdrawals or withdrawals which are in excess of the guaranteed withdrawal. In addition, the rider or contract owner may choose to defer withdrawals. The contract owner may also be subjected to a required minimum distribution in accordance with IRS regulations or a required withdrawal amount based on age and account value.

Another function of the withdrawal period is the valuation of the account 28. At least annually, the benefit base is evaluated in view of the account value in order to adjust the benefit base and withdrawal percentage. If withdrawals above and beyond the guaranteed withdrawal amount (GWA) are taken, the benefit base may be reduced over time. Also, if withdrawals are deferred or the account value grows as an investment with time, the benefit base will increase or step up due to an increasing account value.

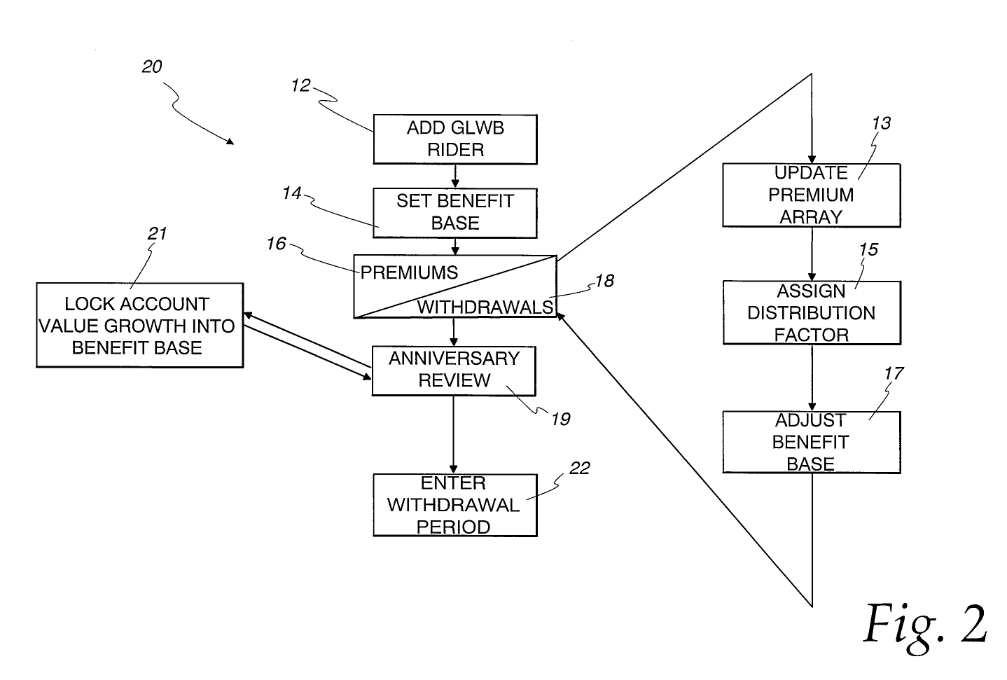

Turning to FIG. 2, there is provided a more detailed illustration of the waiting period in accordance with one embodiment of the invention. Initially, any holder of an annuity contract may add the rider which provides the guaranteed lifetime withdrawal benefit (GLWB). The GLWB rider is added to the annuity contract and has a discrete benefit base. Upon the addition of the rider, the benefit base of the contract is set, 14. During this period, premiums may be made by the contract owner, 16. Withdrawals may also be taken.

With each premium made by the contract owner, the individual premium is identified by date and amount, as well as the age of the contract owner at the premium date. The premium is added to the premium array 13. At that time, the premium array is updated.

A distribution factor is also assigned to the premium 15. The distribution factor may comprise any number which allots a proportion or percentage of the benefit base to the guaranteed withdrawal percentage. One exemplary schedule of distribution factors is found in Table 1 of this application. The distribution factor(s) (F_{D}) may be set by any means known to those of skill in the art having read this specification. The distribution factor generally comprises a multiplier used to determine the appropriate amount of the account value to be distributed to the contract or rider owner while coincidentally allowing the contract or rider writer to secure the appropriate management fee. Relevant considerations include management fees, investment risk, investment return, premium frequency, premium amount, and contract owner's age and life expectancy among other considerations.

Beyond the distribution factor for each premium, an average or weighted distribution factor is used to define the guaranteed withdrawal amount (GWA). The average distribution factor (AF_{D}%) is the product of the distribution factor assigned to each premium and the premium which is then divided by the total premium amount.

A representative formula is:

$${AF}_{D} \% = [ \frac{\sum {F}_{D} \times Premium}{Total Premiums} ] \qquad ( I )$$

Withdrawals affecting the premiums are associated to the appropriate premium as indicated below. The AF_{D}% may then be used to calculate the Benefit Base.

Once the average distribution factor (AF_{D}%) is assigned, the benefit base will be adjusted, 17, for withdrawals in excess of guaranteed withdrawals. Generally, the benefit base is adjusted through the following computation:

$$[ 1 - ( \frac{Change in Value Δ}{Account Value} ) ] \times ( Benefit {Base}_{E} ) = ( Benefit {Base}_{N} ) \qquad ( II )$$

The Benefit Base_{E} is that base value in benefits which exists at the time that the change is made in the account value while Benefit Base_{N} is the new base value for benefits which is used to calculate GWA.

At the anniversary date 17 of the underlying annuity contract, the account value is evaluated 21 in the context of the GLWB rider benefit base. Additions to account value in the form of premiums and return on investment may be used to increase the benefit base. Withdrawals, among other occurrences, from account value may be used to reduce the benefit base of the GLWB rider.

Generally, the account value and the benefit base are analyzed by evaluating the immediate account value against the existing benefit base to determine the appropriateness of the benefit base and whether it needs to be reset. The maximum of the account value or existing benefit base becomes the new benefit base.

Benefit Base_{N}=Maximum (Account Value, Benefit Base_{E}) (III)

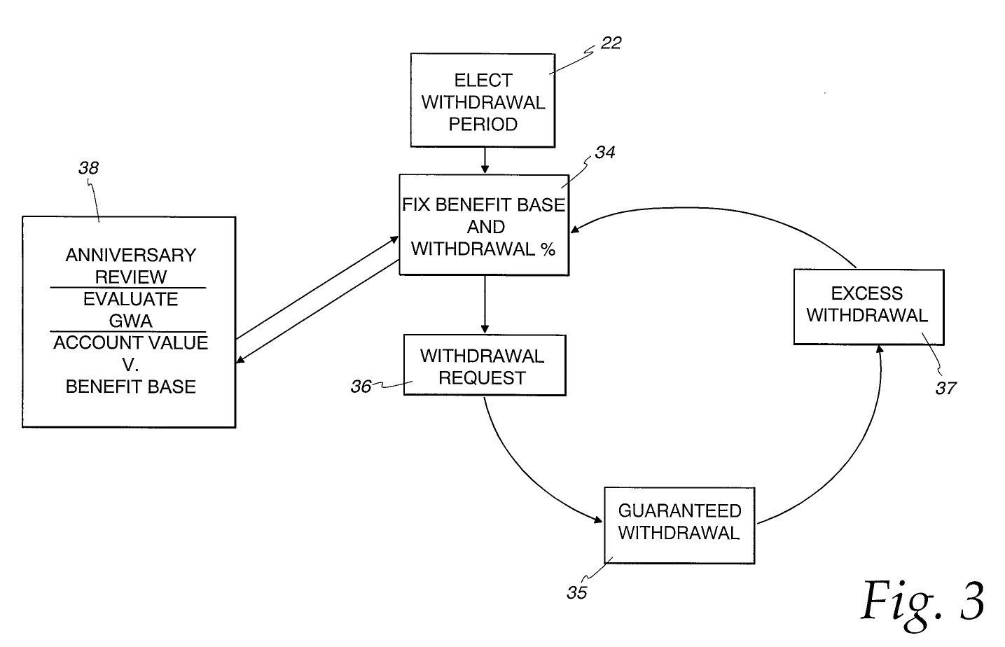

Upon election, the contract owner enters the withdrawal period 22 of the process of the invention. As noted, FIG. 3, the withdrawal period is initiated with the contract owner's election which sets the benefit base and the withdrawal percentage, 34. By setting these numbers, the process of the invention determines the guaranteed withdrawal amount (GWA).

The GWA is defined by the following relationship:

GWA=(Benefit Base_{E})×(AF_{D}%) (IV)

The Benefit Base_{E} is as before, the base in benefits existing within the account at the time of calculation. In turn, the (AF_{D}%) is defined as above as the weighted over the sum of all premiums and withdrawals.

From this point forward, the process of the invention moves to process withdrawals. There are several types of withdrawals which may occur including guaranteed withdrawals and excess withdrawals. GWA's are defined and calculated as shown above.

Withdrawals of part of the account value up to the guaranteed withdrawal mount and have no impact on the GLWB benefit base.

Withdrawals which are intent on removing an excess of the guaranteed withdrawal amount illustrated in the Examples provided below. Generally, the outcome of an excess withdrawal may be predicted by the following formula, which is a version of Formula (II) from above:

$$[ 1 - \frac{( ( Withdrawl - G W A ) = Excess Withdrawl )}{( Account Value - G W A )} ] \times ( Benefit {Base}_{E} ) = ( Benefit {Base}_{N} ) \qquad ( V )$$

The denominator is the account value before excess withdrawal which is generally the account value reduced by any GWA or portion thereof that is taken as part of the excess withdrawal.

The newly revised Benefit Base is then used with the average distribution factor to provide a new GWA which takes the excess withdrawal into consideration. On the annuity contract anniversary dates during withdrawal period, there is a periodic review of the account value to determine if the benefit base should be increased and, in turn, the GWA should be adjusted. Adjustments are taken in accordance with Formula (III), above.

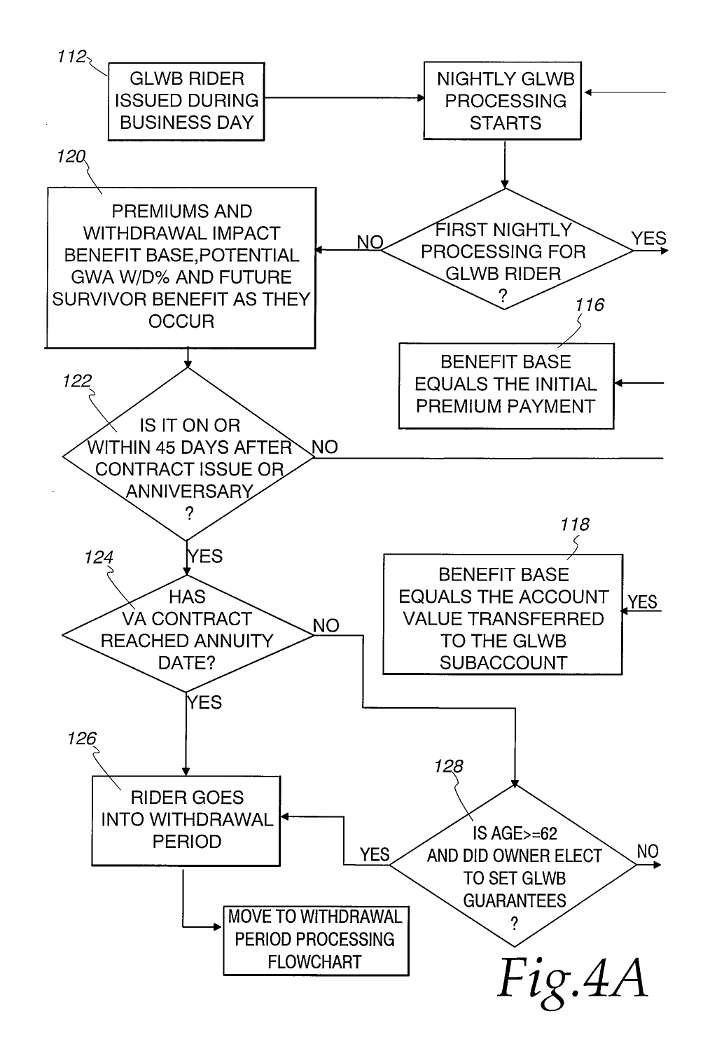

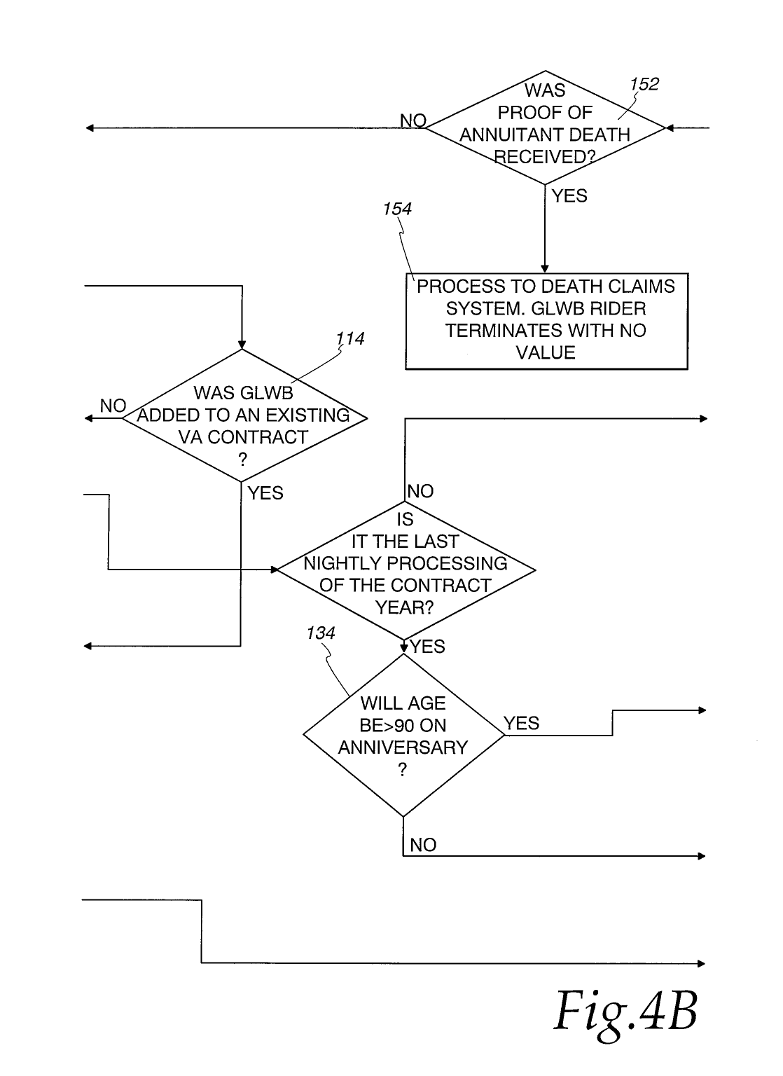

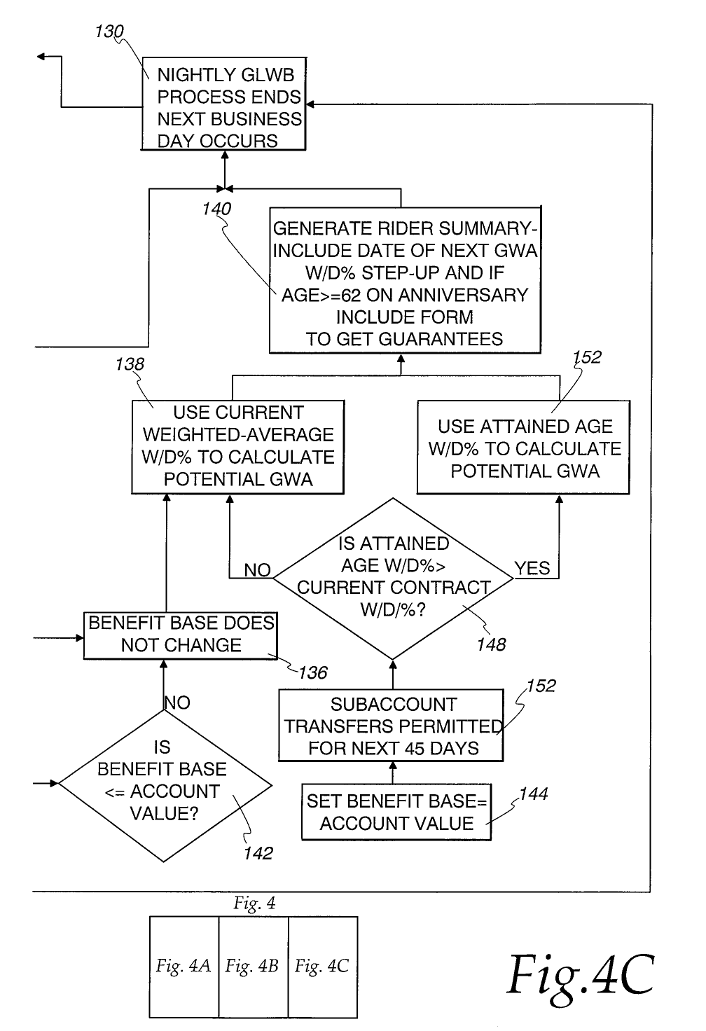

The process of the invention is implemented through means of computation and computer systems. As one of skill in the art will realize having read the specification, any number of computer systems known to those of skill in the art may be used. FIGS. 4 through 7 illustrate various steps in exemplary embodiments of the invention wherein data collection and storage, data processing, computation, evaluation, and/or review may be done manually at a computer terminal, work station, input device or electronically in any manner known to those of skill in the art. The detailed flow of the process of the invention will now be explained and illustrated in accordance with the invention.

### Waiting Period

A GLWB rider may be issued 112 and monitored on any deferred variable annuity, FIG. 4, by a computer or computer based system. In the first instance, assets are managed and the rider is set up by the contract owner. If the guaranteed lifetime withdrawal benefit is added to an existing variable annuity contract 114, the benefit base is set to equal 118 the account value transferred to the GLWB subaccount.

If the GLWB was not added to an existing variable annuity contract 114, the benefit base is set to equal the initial premium payments 116. In either instance, premiums and withdrawals all impact guaranteed withdrawal amounts and the survivor benefit 120.

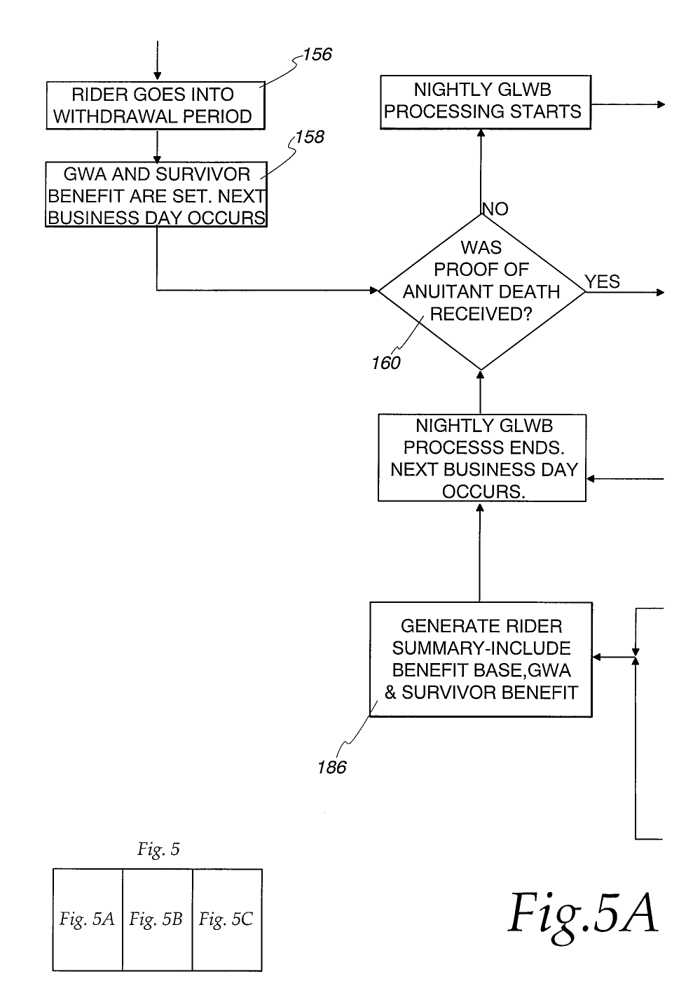

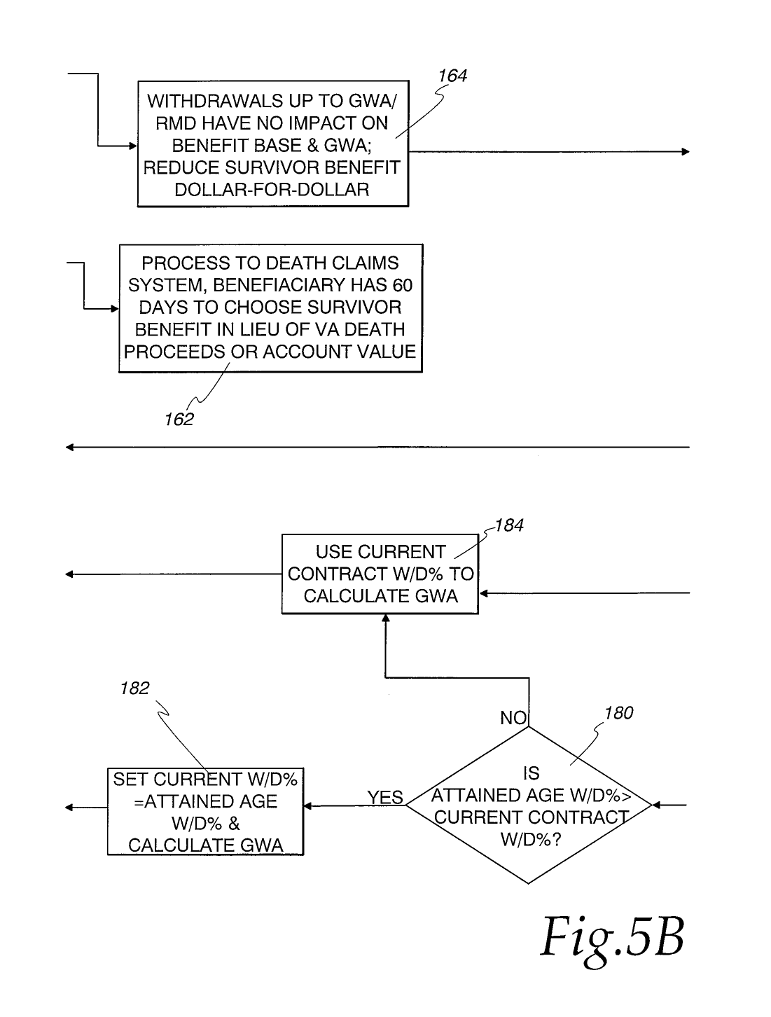

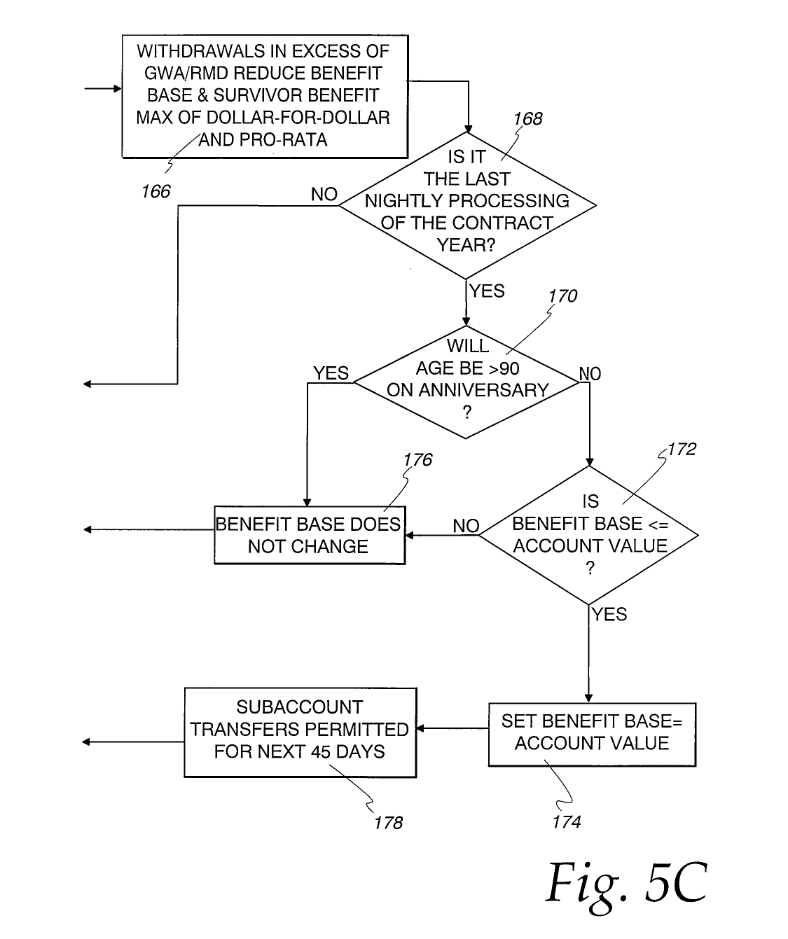

Within 45 days of the contract issue or any anniversary of the contract date 122, a determination is made whether the contract has reached the annuity date 124. If so, the rider proceeds to the withdrawal period 126, FIG. 5. If the variable annuity contract has not reached the annuity date 122, an analysis of the annuitant's age is undertaken 128. When reviewing the annuitants' age and if the contract owner has elected to set the GLWB guarantees, the contract proceeds to the withdrawal period, 126. If the contract owner has not yet set the GLWB Guarantees, 128, the method of the invention continues to restart 130 the periodic cycling to examine the benefit base, annuity date, etc.

If it is past 45 days from the issue date of the contract or anniversary date 132, the annuitant's age is examined 134. If the annuitant is older than 90, the benefit does not change 136 and the current weighted-average withdrawal percentage is used to calculate the GWA 138. A contract summary 140 is generated including the date of the next GWA and withdrawal percentage increase. If the minimum age is 62 at that contract date, forms may be sent the contract owner to set the relevant guarantees. The method of the invention, then continues to restart the periodic cycling to examine the benefit base, annuity date, etc., 130.

If the annuitant is not greater than 90, the benefit base is examined in view of the account value 142. If the benefit base is not less than or equal to the account value, the benefit base does 136 not change and the current weighted-average withdrawal percentage is used 138 to calculate the GWA. The relevant contract summary is generated including the next GWA and withdrawal percentage increase 140. Forms may be sent to the annuitant to set guarantees and the method of the invention then proceeds to further periodic cycling of the other parameters of the process 130.

If under the age of 90 (134) and the benefit base is found to be less than the account value 142, the benefit base is set to equal the account value 144. An evaluation of the attained age withdrawal percentage (Table 2, below) is undertaken in view of the current contract withdrawal percentage 148. If the attained age withdrawal percentage is greater than the contract withdrawal percentage, the attained age withdrawal percentage is used to calculate the potential GWA 150. Sub-account transfers are allowed for the next 45 days, 152, and the relevant contract summary is generated including the next GWA and withdrawal percentage increase. The parameters set forth in Table 2 may be defined by one of skill in the art having read this specification. Relevant factors include those articulated relating to the parameters of Table 1. The method of the invention may then proceed to further periodic cycling of the other parameters of the process.

If the attained age withdrawal percentage is not greater than the current contract withdrawal percentage, the current weighted-average withdrawal percentage is used to calculate potential GWA. The process then proceeds to generate the relevant contract summary and restarts periodic cycling. Sometime within the process of the invention, examination is completed to determine whether an annuitant's death certificate was received 152. If such an event did occur, the contract terminates and the death benefit is paid 154.

### Withdrawal Period

When the process of the invention enters the withdrawal period 156, FIG. 5, benefits including guaranteed withdrawal amount (GWA) and survivor benefits may be set and monitored by a computer based system. If there is proof of death during the withdrawal period 160, the death benefit is processed 162.

Withdrawals are considered during withdrawal period in the context of the GWA. If the withdrawal is not greater than the GWA 164, there is no impact on the benefit base. However, the survivor benefit is reduced on a dollar for dollar basis. Withdrawals which exceed GWA 166 reduce both the benefit base and survivor benefit. The benefit base will be reduced on a dollar for dollar basis and the survivor benefit will be reduced on a pro-rata basis.

At the anniversary of the contract 168, the age of the annuitant is evaluated 170. If the annuitant is under the age of 90, and the benefit base is found to be less than the account value 172, the benefit base is set equal to the account value 174. Subaccount transfers are then permitted for the next 45 days 178. If the age is greater than 90, the benefit base does not change, 176.

In the case of an increase to the benefit base 174, if the attained age withdrawal percentage is greater than the current contract withdrawal percentage 180, the withdrawal percentage is set to equal the attained age withdrawal percentage and used to calculate the guaranteed withdrawal amount 182. If the attained age withdrawal percentage is not greater than the current withdrawal percentage, the current contract withdrawal percentage 184 is used.

A summary of the rider is generated including details on the benefit base, GWA and survivor benefits 186.

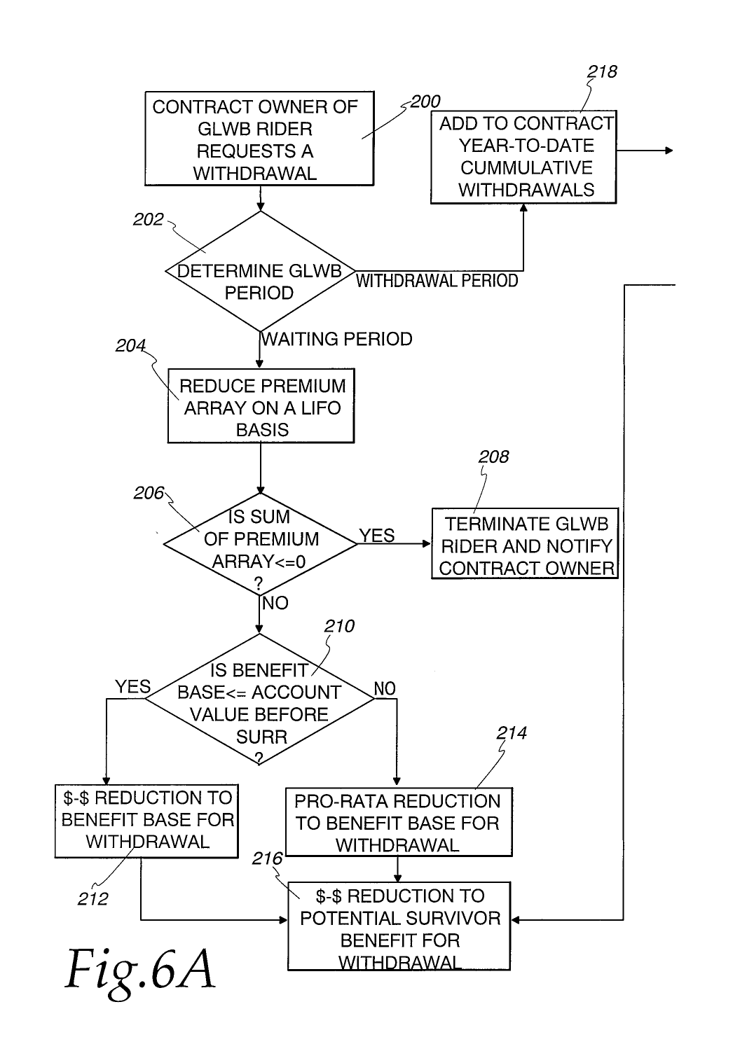

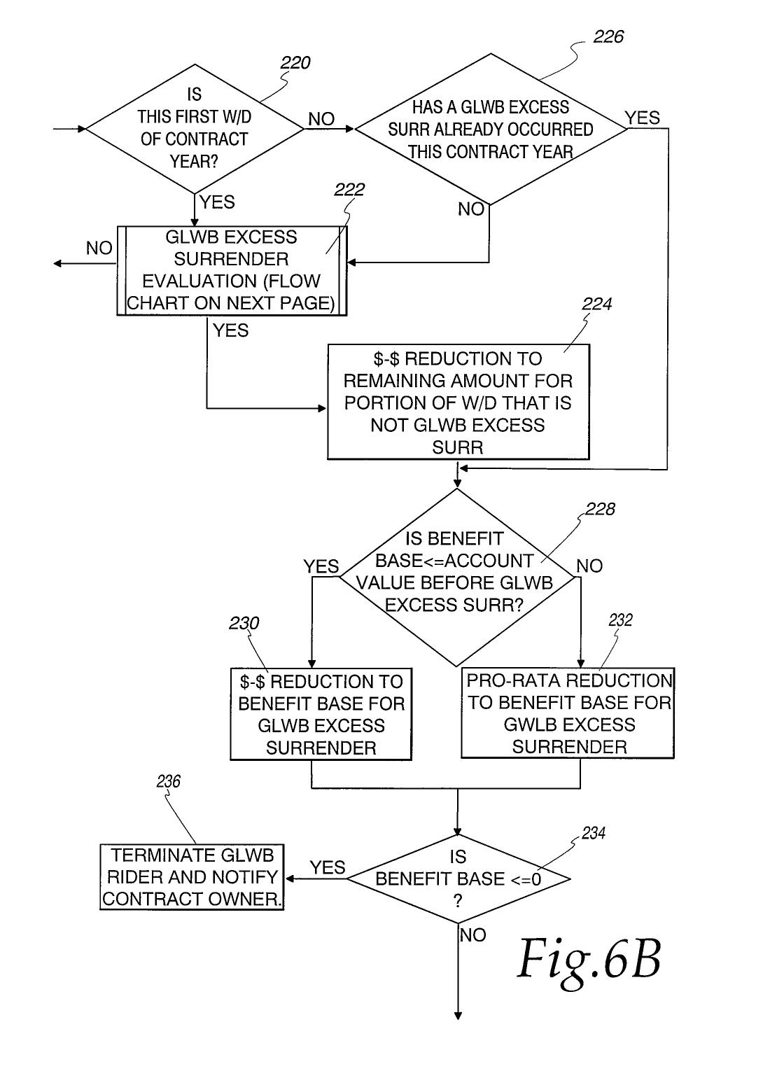

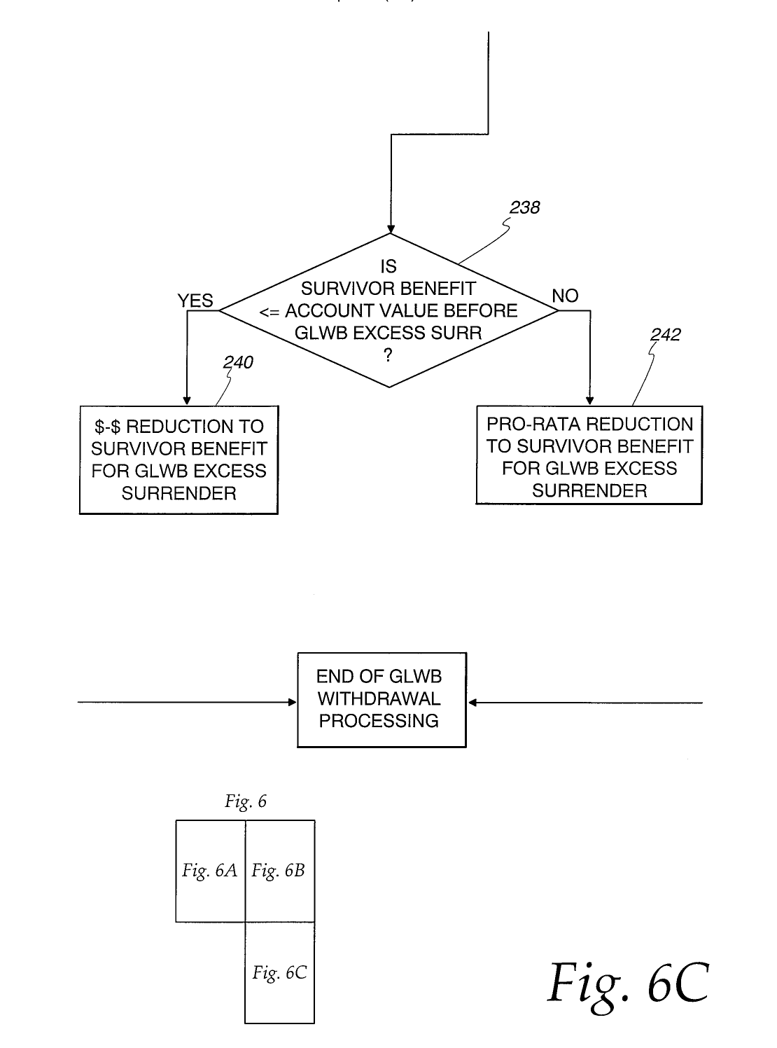

### Partial Withdrawal Evaluation

Where a contract owner requests a withdrawal of account value 200, FIG. 6, there is first a determination of which period the process of the invention is in, waiting or withdrawal 202. Here again, this part of the process of the invention may be completed with a computer or computer assisted system.

If in the Waiting Period, a calculation of a premium array is made based upon the requested withdrawal 204. If it is determined that the withdrawal will result in a premium array that is less than zero 206, the GLWB rider is terminated and the contract owner is notified 208.

If the withdrawal leaves a viable premium array, with a positive value, the benefit base is compared to the account value before the withdrawal 210. If the benefit base is below the account value before the withdrawal, there is a dollar for dollar reduction to the benefit base for the partial withdrawal 212. If the benefit base is not lower than the account value before the withdrawal, then there is a pro-rata reduction to the benefit base in view of the partial withdrawal 214. Under either scenario, there is a dollar for dollar reduction to the potential survivor benefit.

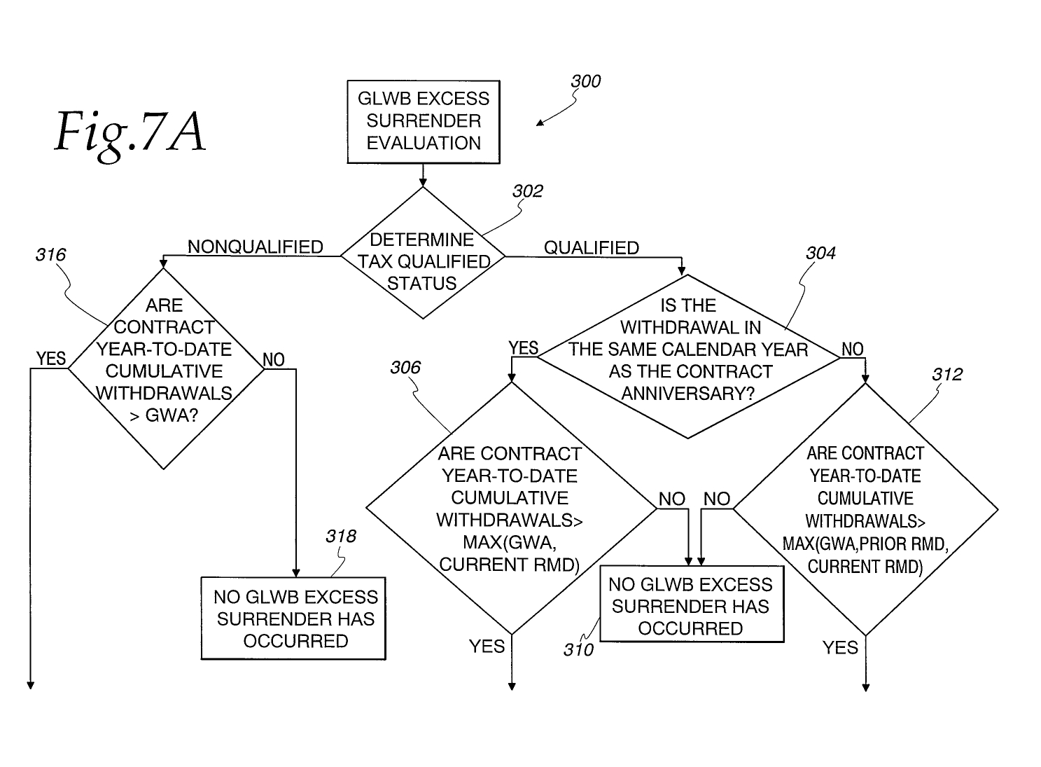

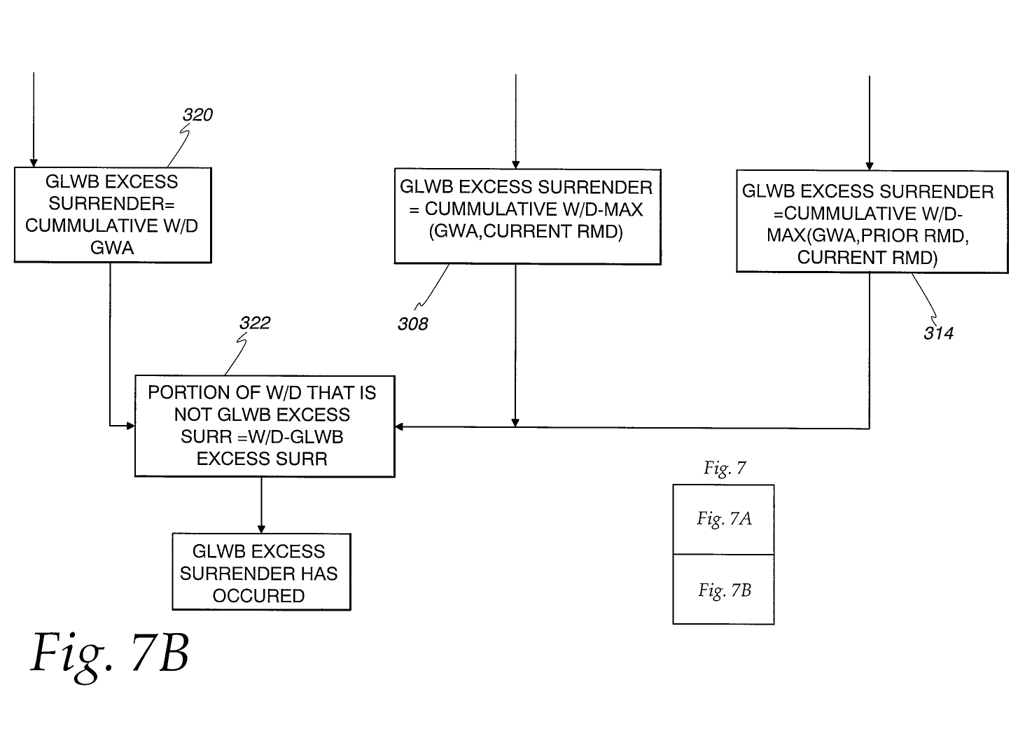

If in the Withdrawal Period 218, the requested partial withdrawal is added to previous withdrawals for the year. If this is the first withdrawal of the contract year 220, then the evaluation is moved to Excess Withdrawal Evaluation 222 at FIG. 7. At this point, there is a dollar for dollar reduction to the survivor benefit for the portion of the withdrawal that is not a GLWB excess withdrawal.

If the partial withdrawal is not the first withdrawal of the contract year 226, an evaluation is undertaken to determine whether the GLWB excess withdrawal has already occurred during the contract year. If it hasn't, an excess withdrawal evaluation is completed as detailed above.

Once the GLWB excess withdrawal evaluation has been completed, analysis of the benefit base in view of the account value before excess withdrawal is undertaken 228. If, before the GLWB excess withdrawal, the benefit base is less than the account value, there is a reduction to the benefit base. The reduction to the benefit base is a dollar for dollar reduction based upon the GLWB excess withdrawal 230. If the benefit base is not less than the account value before excess withdrawal, there is a pro-rata reduction to the benefit base 232. If the resulting benefit base is zero or less 234, the program is terminated and the contract owner is notified 236.

If the resulting benefit base remaining is positive 238, a determination is made as to whether the survivor benefit is less than or equal to the account value before excess withdrawal. If yes 240, there is a dollar for dollar reduction to the survivor benefit. If no 242, there is a pro-rata reduction in the survivor benefit.

### Excess Withdrawal Evaluation

During the withdrawal period, the annuitant may request a withdrawal in excess of the Guaranteed Withdrawal Amount (GWA) from the GLWB account, 300, (FIG. 7). The process of the invention may then generally proceed through several steps. The first step is to determine whether the annuity contract is a tax qualified contract subject to Required Minimum Distribution (RMD). This portion of the process of the invention may also be monitored by computer.

If qualified, the process of the invention then next evaluates whether the withdrawal occurred in the same calendar year as the contract anniversary, 304. If the withdrawal would occur in the same calendar year as the contract anniversary, 306, the process of the invention then evaluates cumulative withdrawals in the contract year to date. In this step, if the contract year-to-date total or cumulative withdrawals are greater than the guaranteed withdrawal amount or the RMD, then the GLWB excess withdrawal is calculated. The GLWB excess withdrawal is equal to the cumulative withdrawals less the maximum of the GWA or RMD 308. If the year-to-date cumulative withdrawals are not greater than the maximum of the GWA or RMD 310, then no excess withdrawal have occurred by the process of the invention.

If the withdrawal is not in the same calendar year as the contract anniversary, 304, cumulative withdrawals for the contract year-to-date are examined. If year-to-date cumulative withdrawals are not greater than the maximum of the GWA, prior or current RMD, 308, then no excess withdrawal has occurred. If year-to-date cumulative withdrawals are greater than the maximum of the GWA, prior or current RMD, 312, an excess withdrawal has occurred. The excess withdrawal allowed is equal to the cumulative total withdrawals minus the maximum of the GWA, prior or current RMD 314.

Returning again to the top of FIG. 7, a different scenario occurs, according to the process of the invention, if the funds are determined to have nonqualified tax status, 302. In this case, an analysis is undertaken to determine whether cumulative withdrawals, year-to-date, are greater than the GWA. If not, no excess withdrawal from the account has occurred 318.

If the year-to-date cumulative withdrawals are greater than the GWA, a GLWB excess withdrawal has occurred, 320. Excess withdrawal is calculated as equal to cumulative withdrawals (year-to-date) minus GWA. In any instance where excess withdrawal has occurred, 322, the portion of the withdrawal that is not an excess withdrawal is equal to the withdrawal minus excess withdrawal.

### WORKING EXAMPLES

The invention will now be illustrated through various exemplary embodiments of the invention. These embodiments are intended to be illustrative only and non-limiting in the scope of the invention.

### Working Example 1

GLWB Waiting Period. The GLWB Waiting Period begins when the rider is issued and continues until the GLWB calculation date is established. During both the GLWB Waiting and Withdrawal Periods, the benefit base is computed and used to calculate the amount of GWA. On the issue date of the GLWB rider, the benefit base is equal to the account value. If the GLWB rider is issued on the contract's date of issue, the benefit base equals the initial premium into the contract. If the rider is added after the contract is issued, the benefit base will equal the account value that is transferred to the subaccount you choose on the date of issue of the rider. At the time the GLWB rider is added, the account is allocated to an investment option.

If the date of issue of the GLWB rider is after the contract's date of issue, the account value will be transferred on the date of issue of the rider to the subaccount elected. A market value adjustment will apply to account value that is transferred from a fixed period allocation more than 30 days before the end of its allocation period. The market value adjustment may increase or decrease the amount transferred.

While the GLWB rider is in force, no transfers among investment options are allowed except that all of the account value may be transferred from one investment option to another within 45 days after any contract anniversary on which the benefit base is increased to equal the account value in accordance with the rider. Automatic transfers of investment options are generally not allowed while the GLWB rider is in force.

Benefit Base during the GLWB Waiting Period. On each contract anniversary during the GLWB waiting period, the benefit base is ratcheted up to equal the account value at the end of the prior day if such adjustment would increase the benefit base. If the account value is less than the current benefit base, the ratchet feature does not change the benefit base. The benefit base is increased by any premiums before the GLWB calculation date. However, no premiums are generally allowable within one year from any partial withdrawal.

During the GLWB waiting period, the benefit base is decreased in the event a partial withdrawal is taken or when the annual administrative charge is taken. The benefit base is decreased by the amount taken if the benefit base is less than or equal to the account value. Otherwise, the benefit base is decreased by the same proportion that the account value is deceased by the amount taken.

### Example 1A

A $5,000 partial withdrawal is taken from a contract in which the account value is $90,000, but the benefit base is $100,000. The resulting benefit base would be calculated as follows:

[1−(5,000/90,000)]×100,000=$94,444.44

The benefit base on the contract anniversary that is elected to be the GLWB calculation date is adjusted as described above for any premiums allocated and partial withdrawals made on or after that contract anniversary and before the notification of election is received of the GLWB calculation date.

GLWB Withdrawal Period. The GLWB Waiting Period ends and the GLWB Withdrawal Period begins on the GLWB calculation date. To set your GLWB calculation date, the contract owner must notify the contract writer within 45 days after an eligible contract anniversary. An eligible contract anniversary is any date on or after the contract anniversary the annuitant reaches 62 years of age and on or before the annuity date. Once you provide the proper notification, the most recent contract anniversary date will become the GLWB calculation date. No further premiums will be accepted after the GLWB calculation date. If there is no election of the GLWB calculation date before the annuity date, the GLWB calculation date will be the annuity date. Once the GLWB calculation date is set, the GWA is calculated. The calculation continues annually until the rider terminates.

Benefit Base During the GLWB Withdrawal Period. On any contract anniversary after the election of the GLWB calculation date is made and on or before the date that the annuitant reaches Age 90, the benefit base is adjusted to equal the account value at the end of the prior date if the adjustment will increase the benefit base. After notice of the election of the GLWB calculation date, the benefit base will be reduced for GLWB excess withdrawals, defined below, but will not be reduced by the amount of the GWA.

Withdrawal Percentage. The Withdrawal Percentage is the percentage that is applied to the benefit base to determine the GWA. The initial withdrawal percentage is determined on the GLWB calculation date. The withdrawal percentage is based on the annuitant's age at which each premium payment is made and the waiting period from the premium payment date until the GLWB calculation date. The initial withdrawal percentage is equal to the weighted average of each adjusted premium multiplied by the applicable percentage applied from the sum of adjusted premiums, each multiplied by its percentage found in Table 1 (above) divided by the sum of adjusted premiums.

Each premium payment is assigned a percentage applied. The withdrawal percentage used to determine the GWA is calculated as the weighted average of the percentages applied.

### Example 1B

For example, assume the account value at the time the rider is added is $100,000 and the annuitant is age 62. Two years later at the annuitant's age 64, the annuitant makes an additional premium of $50,000. Then at age 68, the annuitant adds another $50,000 premium payment. The annuitant decides to begin taking the GWA at age 72. From the chart above, the weighted withdrawal percentage would be:

$$\frac{[ ( 100 \text{,} 000 \times 6 \% ) + ( 50 \text{,} 000 \times 5 \% ) + ( 50 \text{,} 000 \times 4.5 \% ) ]}{200 \text{,} 000} = 5.375 \%$$

For purposes of calculating the Withdrawal Percentage, adjusted premiums are determined by subtracting the amount of partial withdrawals taken from premiums paid on a last-in, first-out basis at the time the partial withdrawal is taken. Generally, the Withdrawal Percentage will be higher if premiums are paid earlier and if partial withdrawals are made later.

### Example 1C

For example, if the Annuitant in the preceding example took a partial withdrawal of $10,000 at Age 63, and a partial withdrawal of $5,000 at age 69, the weighted withdrawal percentage would be:

$$\frac{[ ( 90 \text{,} 000 \times 6 \% ) - ( 50 \text{,} 000 \times 5 \% ) + ( 45 \text{,} 000 \times 4.5 \% ) ]}{185 \text{,} 000} = 5.365 \%$$

In addition, premiums paid within the first three months after a contract anniversary are treated as if they were allocated on that contract anniversary and at the age on that anniversary. All other premiums allocated during the GLWB Waiting Period will be treated as if they were allocated on the next contract anniversary after the date of allocation and at the age on that anniversary. This treatment of premiums is only for purposes of assigning the percentage applied to the adjusted premium amount.

Assume a contract anniversary falls on May 1 of each year. If there is a premium on August 1 of the current year (i.e., within 30 months of the May 1 contract anniversary), that premium will be treated as if it were allocated on May 1 of that year and at the age on that contract anniversary. If there is a premium on September 1 of the current years (i.e., more than 3 months after the May 1 contract Anniversary), that premium will be treated as if it were allocated on May 1 of the following year at the age on May 1 of the following year.

Guaranteed Withdrawal Amount (GWA). The GWA is the amount that can be withdrawn each contract year generally without a withdrawal charge. The GWA is determined on the GLWB calculation date and each contract anniversary thereafter. The GWA is equal to the benefit base (not to exceed $5 million) multiplied by the withdrawal percentage. The GWA may change from year to year depending on whether the benefit base was increased, as described above, or decreased as a result of GLWB excess withdrawals. On any day that the benefit base is decreased during the GLWB Withdrawal Period, the GWA is adjusted, effective as of the next contract anniversary, to equal (a) the lesser of the benefit base on that date or $5,000,000, multiplied by (b) the withdrawal percentage, and the GWA will decrease proportionately. On any contract anniversary that the benefit base has increased during the GLWB withdrawal period to equal the Accumulated Value in accordance with the rider, the withdrawal percentage will be compared to the withdrawal percentages in the following table based on the current age of the annuitant. The larger of the two withdrawal percentages becomes the new withdrawal percentage. The Exemplary Table 2 is based on the annuitant's age under the contract.

TABLE 2
Attained Age Table

| Annuitant Age on | Attained Age |
|---|---|
| Contract Anniversary | Percentage Applied |
| 67-71 | 4.50% |
| 72-76 | 5.00% |
| 77-81 | 5.50% |
| 82-90 | 6.00% |

The benefit base will be multiplied by the new withdrawal percentage to determine the new GWA. If the benefit base increases, the GWA will increase. The GWA will not decrease unless the benefit base decreases. Any decrease in the GWA is effective on the following contract anniversary. No withdrawal charges will apply when partial withdrawals are made during the GLWB Withdrawal Period except to the extent that total withdrawals in a contract year exceed the greater of (a) the GWA, or (b) 10% of the Accumulated Value at the time of the first partial withdrawal in that contract Year. Withdrawals of the GWA are taxed in the same manner as partial withdrawals under the contract.

Withdrawals After The Annuity Date. While the GLWB Rider is in force, beginning on the Annuity Date, the annuitant will be required to withdraw a minimum amount from the contract each year called a Required Withdrawal Amount. While the GLWB Rider is in force, instead of paying the annuity income beginning on the annuity date according to the contract, an amount equal to the excess, if any, of the required withdrawal amount over the sum of any partial withdrawals taken during that contract year is paid to the annuitant. The required withdrawal amount is the greater of the GWA and the account value at the end of the prior contract year multiplied by the amortization factor for the age in the current contract year. Exemplary amortization factors will not exceed the factors shown in Table 3 below:

TABLE 3
Amortization Table Used after the Annuity Date

| Age | Factor |
|---|---|
| 90 | 6.04% |
| 91 | 6.24% |
| 92 | 6.47% |
| 93 | 6.71% |
| 94 | 7.00% |
| 95 | 7.31% |
| 96 | 7.66% |
| 97 | 8.06% |
| 98 | 8.52% |
| 99 | 9.05% |
| 100 | 9.67% |
| 101 | 10.40% |
| 102 | 11.28% |
| 103 | 12.36% |
| 104 | 13.70% |
| 105 | 15.43% |
| 106 | 17.72% |
| 107 | 20.93% |
| 108 | 22.63% |
| 109 | 33.30% |
| 110 | 47.14% |
| 111 | 52.63% |

If a required minimum distribution (RMD) is defined for the contract by Section 401(a)(9) of the Internal Revenue Code, then at the end of each calendar year, an amount equal to the excess, if any, of the RMD for that calendar year over the sum of any partial withdrawals taken during that calendar year will be distributed during the calendar year.

Any amounts taken are treated as partial withdrawals under the contract.

Effects of Partial Withdrawals During the GLWB Withdrawal Period. If the sum of partial withdrawals within a contract year exceeds the larger amount of the GWA for that contract year; the RMD for that calendar year, if any, as we determine for the contract; and if that day is in a contract year that began in the prior calendar year, the RMD, if any, for the prior calendar year for this contract:

This excess amount is a GLWB excess withdrawal. Any subsequent partial withdrawal taken within the same contract year in which a GLWB excess withdrawal is made will also be considered a GLWB excess withdrawal.

A GLWB excess withdrawal affects the calculation of the benefit base. If the benefit base is less than or equal to the account value, the benefit base is decreased by the amount of the GLWB excess withdrawal. Otherwise, the benefit base is decreased by the following ratio:

$$\frac{a}{b - ( c - a )}$$

### Where:

a=GLWB excess withdrawal amount
b=Account value prior to withdrawal
c=partial withdrawal amount

No withdrawal charges will apply to partial withdrawals made during the GLWB withdrawal period to the extent partial withdrawals in a contract year doe not exceed the guaranteed withdrawal amount, or 10% of the account value at the time of the first partial withdrawal in a contract year.

GLWB Survivor Benefit. If the annuitant dies during the GLWB withdrawal period and before the annuity date, the beneficiary may elect to receive the GLWB survivor benefit, if any, in lieu of any death proceeds under the contract. If the annuitant dies after the annuity date, the beneficiary may elect to receive the GLWB survivor benefit, if any, in lieu of the account value of the contract.

The beneficiary must notify their contract writer of the election to receive the GLWB survivor benefit within 60 days after we receive proof of death of the annuitant. On the date the GLWB rider is issued, the GLWB survivor benefit equals the account value. Thereafter, the GLWB survivor benefit increases the day the premium is applied by the amount of the premium, and decreases on a day in which a partial withdrawal or annual administrative charge is deducted by the amount of the partial withdrawal or administrative charge.

If a guaranteed withdrawal is taken, the GLWB survivor benefit is reduced by the amount of the withdrawal. However, if a GLWB excess withdrawal is taken, and the GLWB survivor benefit is less than or equal to the account value, the survivor is decreased by the amount of the excess withdrawal. If the GLWB survivor benefit is greater than the account value, the benefit is first decreased by the amount of the withdrawal that does not represent the GLWB excess withdrawal. The remaining amount is then decreased by the following ratio:

$$\frac{a}{b - ( c - a )}$$

### Where:

a=GLWB Excess Withdrawal amount
b=Accumulated value prior to withdrawal
c=partial withdrawal amount

If the contract beneficiary chooses the survivor benefit, benefit payments will continue until the sum of payments equals the GLWB Survivor Benefit. The payment period will not exceed the life expectancy of the beneficiary. If the annuitant dies before the annuity date and the spouse of the annuitant is the sole primary beneficiary, the surviving spouse may elect to continue the contract as annuitant and owner. At the time this election becomes effective, the account value of the contract and any excess of death proceeds over the account value on that date will remain in the investment option in which the account value was allocated at that time, but will no longer be subject to the GLWB risk charge. The surviving spouse is credited with the investment option accumulation units that are not subject to the GLWB risk charge. This election results in a termination of the GLWB Rider. If the election to continue the contract is not made within 60 days from the date proof of death is received, the surviving spouse will be deemed to have elected to continue the contract effective on the exchange date. This also results in the termination of the GLWB rider.

Termination of the GLWB Rider. The GLWB rider may be terminated at any time provided it is at least two years after the rider is issued. The Rider also terminates at the earliest of: the date of contract termination; the date satisfactory proof of the death of the annuitant is received; the date the annuitant elects to receive annuity income under the contract; the date during the GLWB waiting period that the sum of withdrawals made and annual administrative charges deducted for this contract exceeds the sum of premiums paid; or the date during the GLWB withdrawal period that the benefit base is reduced to zero.

If the contract terminates because the GWA that is withdrawled exceeds the account value, the GWA will be withdrawn each year for as long as the annuitant is alive. If the GLWB rider terminates for reasons other than the termination of the entire contract, the account value will remain in the same investment option but is no longer subjected to the GLWB risk charge. The annuitant is credited with the investment option accumulation units that are not subject to the GLWB risk charge in lieu of units that are subject to the charge. Once the GLWB rider terminates, the GLWB risk charge will also cease. If the rider terminates after the annuity date and there is accumulated value remaining, annuity income is distributed according to the contract.

### Example 2

### During GLWB Waiting Period

Premiums can only be paid during the GLWB Waiting Period and generally increase the benefit base by the amount of the premium paid.

Withdrawals generally decrease the benefit base and may be subject to charges if the amount taken in a contract year exceeds 10% of the Account Value at the time of the first withdrawal in that year.

### Example 2A

### Partial Withdrawal—Account Value before withdrawal>=Benefit Base

Account Value before partial withdrawals = $125,000
Benefit Base before partial withdrawals = $120,000
Partial Withdrawals = $10,000
$\begin{matrix}Benefit Base = Benefit Base before withdrawal - Partial Withdrawal \\ = 120 , 000 - \$10 , 000 \\ = \$110 , 000\end{matrix}$

### Example 2B

### Partial Withdrawal—Account Value before withdrawal<Benefit Base

Account Value before partial withdrawal = $100,000
Benefit Base before partial withdrawal = $120,000
Partial Withdrawal = $10,000
$\begin{matrix}Benefit Base = Benefit Base before withdrawal \frac{\{ AV after withdrawal \}}{AV before withdrawal} \\ = \$120 , 000 \{ ( \$100 , 000 - \$10 , 000 ) / \$1000 , 000 \} \\ = \$120 , 000 \; 90 \% \\ = \$108 , 000\end{matrix}$

### Example 3

### On GLWB Calculation Date

The initial Withdrawal Percentage, GWA and GLWB Survivor benefit are determined on the GLWB Calculation Date.

### Example 3A

### Single Premium Paid at Issue. No Partial Withdrawals Taken. Benefit Base is Ratched Up to Equal Account Value on One or More Contract Anniversaries.

Annuitant age at GLWB rider issue = 50
Account Value (premium paid) at GLWB rider issue = $100,000
Annuitant age when GLWB Calculation date elected = 65
Benefit Base = $200,000
Waiting Period = age 65 − age 50 = 15 years
Withdrawal Percentage (from table lookup) = 6.0%
$\begin{matrix}GWA = Benefit Base Withdrawal Percentage \\ = \$200 , 000 \; 6.0 \% \\ = \$12 , 000\end{matrix}$
$\begin{matrix}Surviror Benefit = Account Value at GLWB rider issue + premiums \\ paid - partial withdrawals - annual administrative \\ charges \\ = \$100 , 000\end{matrix}$

### Example 3B

### Additional Premium and Partial Withdrawals After Issue.

Using the example above with an additional premium of $60,000 paid at
annuitant age 55 and a $10,000 partial withdrawal at annuitant age 60

Percentage applied to $100,000 premium paid at age 50 is 6%
Additional premium paid at age 55, Waiting Period = 10 Years
Withdrawal Percentage (from table lookup) = 5% applied to
$50,000 ($60,000 premium less $10,000 partial withdrawal)
Withdrawal Percentage is weighted average:

[$100,000 × 6% plus $50,000 × 5%]/$150,000 = 5.67%

$\begin{matrix}GWA = Benefit Base Withdrawal Percentage \\ = \$250 , 000 \; 5.67 \% \\ = \$14 , 175\end{matrix}$
$\begin{matrix}Surviror Benefit = Account Value at GLWB rider issue + \\ premiums - partial withdrawals - annual \\ administrative charges \\ = \$100 , 000 + \$60 , 000 - \$10 , 000 \\ = \$150 , 000\end{matrix}$

### Example 4

### During GLWB Withdrawal Period

If cumulative partial withdrawals during the contract year are less than either the GWA or the Required Minimum Distribution amount (if it applies), the Benefit Base will not decrease and the GWA will not decrease as a result of the partial withdrawals. A GLWB Excess Withdrawal will result in a reduction to the benefit base, the GWA for the next contract year and the GLWB Survivor Benefit.

### Example 4A

### GLWB Excess Withdrawal When Account Value>Benefit Base.

Values before Partial Withdrawal
Benefit Base = $202,000
Account Value = $225,000
GLWB Survivor Benefit = $95,000
GWA = $12,120
Partial Withdrawal = $20,000
GLWB Excess Withdrawal = $20,000 − $12,120 = $7,880
Values after Partial Withdrawal
$\begin{matrix}Benefit Base = Benefit Base before Withdrawal - GLWB Excess \\ Withdrawal \\ = \$202 , 000 - \$7 , 880 \\ = \$194 , 120\end{matrix}$
GWA for next contract year = $194,120 6.0% = $11,647.20
$\begin{matrix}GLWB Survivor Benefit = Surviror Benefit before Withdrawal - Partial \\ Withdrawal \\ = \$95 , 000 - \$20 , 000 \\ = \$75 , 000\end{matrix}$

### Example 4B

### Large GLWB Excess Withdrawal When Accumulated Value>Benefit Base.

Values before Partial Withdrawal
Benefit Base = $202,000
Accumulated Value = $225,000
GWA = $12,120
Partial Withdrawal = $215,000
GWLB Excess Withdrawal = $215,000 − 12,120 = $202,880
Values after Partial Withdrawal
$\begin{matrix}Benefit Base = Benefit Base before Withdrawal - GLWB Excess \\ Withdrawal \\ = \$202 , 000 - \$202 , 880 \\ = \$0 ( the Benefit Base cannot be negative )\end{matrix}$
The Benefit Base has been reduced to zero. The GLWB rider will
terminate. The variable annuity contract will remain with account value
of $10,000 ($225,000 − $215,000).

### Example 4C

### GLWB Excess Withdrawal When Account Value<Benefit Base.

Values before Partial Withdrawal
Benefit Base = $202,000
Accumulated Value = $80,000
GLWB Survivor Benefit = $95,000
GWA = $12,120
Partial Withdrawal = $20,000
GLWB Excess Withdrawal = $20,000 − $12,120 = $7,880
Values after Partial Withdrawal
$\begin{matrix}Benefit Base = Benefit Base before Withdrawal \\ \frac{\{ GLWB Excess Withdrawal \}}{AV before Excess Withdrawal} \\ = \$202 , 000 [ 1 - \$7 , 880 / ( \$80 , 000 - \$12 , 120 ) ] \\ = \$202 , 000 ( 1 - .116087 ) \\ = \$178 , 550.43\end{matrix}$
GWA for next contract year = $178,550.43 6.0% = $10,713.03
GLWB Survivor Benefit before Excess Withdrawal = $95,000 −
$12,120 = $82,880
$\begin{matrix}GLWB Survivor Benefit = Surv Ben before withdrawal \\ \{ 1 - \frac{\{ GLWB Excess Withdrawal \}}{AV before Excess Withdrawal} \\ = \$82 , 880 [ 1 - \$7 , 880 / ( \$80 , 000 - \$12 , 120 ) ] \\ = \$82 , 880 ( 1 - .116087 ) \\ = \$73 , 258.71\end{matrix}$

### Example 4D

### Large GLWB Excess Withdrawal When Account Value (AV)<Benefit Base.

Values before Partial Withdrawal
Benefit Base = $202,000
Account Value = $80,000
GLWB Survivor Benefit = $95,000
GWA = $12,120
Partial Withdrawal = $75,000
GLWB Excess Withdrawal = $75,000 − $12,120 = $62,880
Values after Partial Withdrawal
$\begin{matrix}Benefit Base before surr \{ 1 - \frac{\{ GLWB Excess Withdrawal \}}{AV before Excess Withdrawal} = \\ \$202 , 000 [ 1 - \$62 , 880 / ( \$80 , 000 - \$12 , 120 ) ] = \\ \$200 , 000 ( 1 - .926341 ) = \$14 , 879.12\end{matrix}$
GWA for next contract year = $14,879.12 6.0% = $892.75
GLWB Survivor Benefit before Excess Withdrawal = $95,000 −
$12,120 = $82,880
$\begin{matrix}GLWB Surviror Benefit = Surv Ben before withdrawal \\ \{ 1 - \frac{\{ GLWB Excess Withdrawal \}}{AV before Excess Withdrawal} \\ = \$82 , 880 [ 1 - \$62 , 880 / ( \$80 , 000 - \$12 , 120 ) ] \\ = \$82 , 880 ( 1 - .926341 ) \\ = \$6 , 104.86\end{matrix}$

### Example 4E

### GLWB Excess Withdrawal of Full Account Value.

Values before Partial Withdrawal
Benefit Base = $202,000
Account Value = $80,000
GLWB Survivor Benefit = $95,000
GWA = $12,120
Partial Withdrawal = $80,000
GLWB Excess Withdrawal = $80,000 − $12,120 = $67,880
Values after Partial Withdrawal
$\begin{matrix}Benefit Base before withdrawal \{ 1 - \frac{\{ GLWB Excess Withdrawal \}}{AV before Excess Withdrawal} = \\ \$202 , 000 [ 1 - \$67 , 880 / ( \$80 , 000 - \$12 , 120 ) ] = \$200 , 000 ( 1 - 1 ) = \$0 .00\end{matrix}$
GWA for next contract year = $0.00 6.0% = $0.00
GLWB Survivor Benefit before Excess Withdrawal = $95,000 −
$12,120 = $82,880
$\begin{matrix}GLWB Survivor Benefit = Survivor Benefit before Withdrawal \\ \{ 1 - \frac{\{ GLWB Excess Withdrawal \}}{AV before Excess Withdrawal} \\ = \$82 , 880 [ 1 - \$67 , 880 / ( \$80 , 000 - \$12 , 120 ) ] \\ = \$82 , 880 ( 1 - 1 ) \\ = \$0 .00\end{matrix}$

A GLWB Excess Withdrawal equal to the Account Value prior to the GLWB Excess Withdrawal will reduce the Benefit Base to $0 and terminate the GLWB rider.

From the preceding description of the preferred embodiments, it is evident that the objects of the invention are attained. Although the invention has been described and illustrated in detail, it is to be clearly understood that the same is intended by way of illustration and example only and is not to be taken by way of limitation. The spirit and scope of the invention are to be limited only by the terms of the appended claims.

1. A method for administering a guaranteed lifetime withdrawal benefit, said method comprising the steps of:
initiating the waiting period;
calculating the account value to determine the benefit base;
periodically determining the account value;
comparing the account value to the benefit base;
initiating the withdrawal period by fixing the benefit base and withdrawal percentage;
calculating the distribution factor; and
calculating the guaranteed withdrawal.

2. The method of claim 1, wherein premiums are made during the waiting period.

3. The method of claim 2, wherein premiums are made and said distribution factor is assigned to each premium based upon the date of the premium and the annuitant's age at the date the distribution factor is calculated.

4. The method of claim 3, wherein an average distribution factor is calculated periodically.

5. The method of claim 4, wherein said average distribution factor is compared to the attained age factor.

6. The method of claim 5, wherein said average distribution factor is compared to the attained age factor to provide a new current average distribution factor.

7. The method of claim 6, wherein the guaranteed withdrawal amount is the product of the benefit base and the new average distribution factor.

8. The method of claim 1, wherein the guaranteed lifetime withdrawal benefit is added on or before the age of 50.

9. The method of claim 1, wherein the guaranteed lifetime withdrawal benefit is added on or before the age of 85.

10. The method of claim 1, wherein there is a minimum account value before adding the benefit.

11. The method of claim 10, wherein the minimum account value is at least about $25,000 before initiating the withdrawal period.

12. The method of claim 10, wherein the minimum account value is not reached.

13. The method of claim 1, wherein the account value is determined on the anniversary date of the underlying annuity.

14. The method of claim 1, wherein upon addition, the benefit immediately enters the withdrawal period.

15. The method of claim 1, wherein the distribution factor is increased for each premium by an incremental value when the time before withdrawal is extended for that premium.

16. The method of claim 15, wherein said given period ranges from about five years to fifteen years.

17. The method of claim 16, wherein said given period is at least about five years.

18. The method of claim 1, wherein the account value is determined daily.

19. The method of claim 1, wherein after the account value and benefit base are compared, and said benefit base is increased to the account value.

20. A method for administering a guaranteed lifetime withdrawal benefit, said method comprising the steps of:
a) adding the guaranteed lifetime withdrawal benefit to an annuity contract;
b) initiating the withdrawal period by setting the benefit base calculation date and by fixing the benefit base and withdrawal percentage.

21. The method of claim 20, wherein the guaranteed lifetime withdrawal benefit comprises a benefit base which increases during the withdrawal period.

22. The method of claim 21, wherein the benefit base is calculated annually on the anniversary of the annuity during the withdrawal period.

23. The method of claim 22, wherein an increase in the benefit base results in an increase guaranteed withdrawal amount during the withdrawal period.

24. The method of claim 20, wherein premiums are made during the waiting period.

25. The method of claim 24, wherein said distribution factor is assigned to each premium based upon the date of the premium and the age of the contract owner at the date the distribution factor is calculated.

26. The method of claim 25, wherein an average distribution factor is calculated periodically.

27. The method of claim 26, wherein said average distribution factor is compared to the contract owner's attained age factor.

28. The method of claim 27, wherein said existing average distribution factor is compared to the attained age factor to provide a new average distribution factor.

29. The method of claim 28, wherein the guaranteed withdrawal amount is the product of the benefit base and the current average distribution factor.

30. The method of claim 20, wherein the guaranteed lifetime withdrawal benefit is added on or before age 50.

31. The method of claim 20, wherein the guaranteed lifetime withdrawal benefit is added on or before age 85.

32. The method of claim 20, wherein there is a minimum account value before adding the benefit.

33. The method of claim 32, wherein the minimum account value is at least about $25,000 before initiating the withdrawal period.

34. The method of claim 32, wherein the minimum account value is not reached.

35. The method of claim 20, wherein the benefit base is determined on the anniversary date of the annuity.

36. The method of claim 20, wherein upon adding, the benefit immediately enters the withdrawal period.

37. The method of claim 20, wherein upon adding, the distribution factor is increased for each premium by an incremental value when the time before the withdrawal is extended for that premium.

38. The method of claim 37, wherein said given period is at least about five years.

39. The method of claim 20, additionally comprising the steps of calculating a distribution factor.

40. The method of claim 39, additionally comprising the steps of calculating the guaranteed withdrawal amount.

41. The method of claim 40, wherein the guaranteed withdrawal amount is the product of the benefit base and the average distribution factor.

42. The method of claim 41, wherein the average distribution factor is compared to the attained age factor periodically.

43. The method of claim 20, wherein said withdrawal period may be initiated on the anniversary date of the annuity up to the annuity date.

44. The method of claim 42, wherein said periodic comparison is completed manually.
